(19) United States
(12) Patent Application Publication
(10) Pub. No.: US 2012/0013987 A1
(43) Pub. Date: Jan. 19, 2012

(54) LIGHT SCATTERING SHEET AND METHOD FOR PRODUCING THE SAME

(76) Inventor: Kazuhiro OKI, Minami-Ashigara-shi (JP)

(21) Appl. No.: 13/183,819

(22) Filed: Jul. 15, 2011

(30) Foreign Application Priority Data
Jul. 16, 2010 (JP) 2010-161950
Jun. 10, 2011 (JP) 2011-130456

(51) Int. Cl. G02B 5/02; B05D 3/00; B05D 5/06

(52) U.S. Cl. 359/599; 427/164

(57) ABSTRACT

A light scattering sheet includes: a transparent support; and a light scattering layer on the transparent support, the light scattering layer having a phase-separated convexo-concave structure formed by spinodal decomposition of a solution containing two or more resin materials capable of phase-separation from each other are dissolved in a solvent. In the light scattering layer, the phase-separated convexo-concave structure is formed into a sea-island structure of two or more resin materials including a styrene-acrylonitrile copolymer, and a plurality of domains constituting the islands have random shapes mainly having a string shape, and a transmitted image definition measured according to JTS K 7374 using an optical comb having a width of 2.0 mm is 10% or more and less than 25%.

### BACKGROUND OF THE INVENTION

1. Field of the Invention

The presently disclosed subject matter relates to a light scattering sheet and a method for producing the same, particularly to a light scattering sheet used for a liquid crystal display device and a method for producing the same.

2. Description of the Related Art

In recent years, a liquid crystal display has been widely used because it is thin and light. A cold-cathode tube (CCFL: Cold Cathode Fluorescent Lamp) and an LED (Light Emitting Diode) are generally used as a light source of a back light unit which constitutes a light source of a liquid crystal display. These light sources are a linear light source or a point light source and have luminance distribution. A member for scattering light such as a light scattering (or light diffusion) sheet is used to convert these light sources into a surface light source.

Further, a prism sheet, a reflection-type polarizing film, and the like are used to condense light to increase the luminance of a light source. Furthermore, it is known that when a film having a regular structure like a prism sheet is installed, distribution of luminance will occur in a specific direction, and in order to convert this distribution into a surface light source, light is scattered by providing a light scattering sheet in the uppermost part of backlight.

In addition, when an optical path is controlled by a prism sheet, the light entering into a polarizing plate is scattered by providing a light scattering sheet so that the optical path-controlled light may not interfere with the pixel of a liquid crystal cell to produce moire.

For example, Japanese Utility Model application Laid-Open No. 05-73602 proposes a light scattering sheet in which bead particles are buried in a synthetic resin, as a light scattering sheet as described above. Further, Japanese patent application Laid-Open No. 05-169015 proposes a light scattering sheet in which convexo-concave shape is formed on the surface thereof with a roll intaglio engraved with a fine emboss shape.

However, although the scattering properties of a light scattering layer with particles need to be controlled by the particle size, it is difficult to control the aggregation and dispersion of particles, and satisfactory scattering properties cannot be obtained. Further, since embossing provides regular shape, a peak of a scattering angle is produced at a specific angle, which poses a problem of glare and the like.

A phase separation method is a solution to these problems in the production of light scattering sheets with particles or by embossing. The phase separation method comprises coating a transparent support with a solution containing two or more resin materials capable of phase-separation from each other are dissolved in a solvent to form a coating layer and evaporating the solvent from the coating layer to perform phase separation. Thereby, a light scattering layer with a phase-separated convexo-concave structure can be formed on a transparent support.

For example, Japanese patent application Laid-Open No. 2004-126495 proposes an anti-glare film with a phase-separated structure formed by spinodal decomposition of a solution in which at least one polymer and at least one curable resin precursor are uniformly dissolved. Further, Japanese patent application Laid-Open No. 2005-195819 discloses an anti-glare film which has a surface with a fine convexo-concave structure and in which the proportion of a region having a tilt angle to the surface of 2.5 to 7.5° is 20% or less. Such a film or sheet produced by utilizing phase separation is arranged at the outermost surface of a liquid crystal display device to prevent reflection of external light.

Incidentally, conventional light scattering sheets are usually present as an independent member, which increases the number of laminated sheets. Therefore, a reduction in the thickness of a light scattering sheet is required, but there is a limit in the reduction in thickness in terms of the strength or the like of a light scattering sheet. Accordingly, as a method of solving the problem of thickness due to lamination, Japanese patent application Laid-Open No. 2000-75134 discloses a light diffusion polarizing plate in which a reduction in the number of members and a reduction in thickness have been attempted by giving a light scattering function to a protective sheet on the light entrance side of the protective sheets which are adhered to the front and back surfaces of the polarizing plate. According to this disclosure, it is supposed that a surface light source can be obtained without using a conventional light scattering sheet.

In this case, triacetyl cellulose (TAC) is usually used as a transparent support because properties required for the protective sheet include a small optical anisotropy such as phase difference.

### SUMMARY OF THE INVENTION

Incidentally, it is required that a light scattering sheet have high scattering properties and can be prevented from the occurrence of luminance unevenness or moire as described above, and it is important for this purpose that the light scattering sheet have a low image definition, specifically a transmitted image definition of 10% or more and less than 25%. Further, the light scattering sheet preferably has a phase-separated convexo-concave structure in which the proportion of the surface tilt angle in the range of 2.5° to 7.5° is 21% to 50% (proportion of a region with a tilt angle of 2.5° to 7.5°).

In order to produce a light scattering sheet having such optical properties, it is necessary to dry a coating layer prepared by applying a solution to a transparent support so that rotating convection may not occur in the coating layer. That is, a light scattering sheet having such optical properties is formed into a sea-island structure composed of two or more resin materials, in which a plurality of domains constituting the islands have random shapes mainly having a string shape.

However, if the coating layer is subjected to low speed drying (for example, room temperature drying) in the initial drying in which a solvent concentration of a coating layer is high, like a method for producing a light scattering sheet by a conventional phase separation method, rotation convection will occur in the coating layer due to the difference in temperature between the upper layer and the lower layer of the coating layer or the difference in density between the upper layer and the lower layer. A problem is that this produces a convective cell in the coating layer to form a regular or periodic phase-separated convexo-concave structure having a plurality of cellular domains, and a light scattering sheet with a low image definition having a transmitted image definition of 10% or more and less than 25% cannot be obtained.

Considering this, the inventor has proposed to subject a coating layer to high speed drying immediately after coating and forming the coating layer on a transparent support to thereby suppress the occurrence of rotating convection in the coating layer, thereby producing a light scattering sheet with a low image definition.

However, a problem is that it is very difficult to produce a light scattering sheet with a low image definition due to the drying unevenness accompanying the high speed drying. In particular, when a light scattering sheet having a large area is produced, the drying unevenness will produce a variation in the low image definition.

The fact of the matter is that, in order to produce a light scattering sheet with a low image definition, there is no choice but to subject a coating layer to low speed drying immediately after forming the coating layer.

The presently disclosed subject matter has been made in view of such circumstances, and an object of the presently disclosed subject matter is to provide a light scattering sheet having a transmitted image definition of 10% or more and less than 25% and excellent in moire-eliminating performance and to provide a method for producing such a light scattering sheet, because a phase-separated convexo-concave structure in which a plurality of domains have random shapes mainly having a string shape can be stably formed even if a coating layer is subjected to low speed drying at room temperature in the initial drying of the coating layer in producing the light scattering sheet by a phase separation method.

Further, an object of the presently disclosed subject matter is to provide a method for producing a light scattering sheet and a light scattering sheet with which a reduction in the thickness of a liquid crystal display device can be achieved by reducing the number of members by using triacetyl cellulose as the transparent support so as to make the light scattering sheet serve also as a protective sheet of a polarizing plate.

In order to achieve an object as described above, there is provided a method for producing a light scattering sheet according to an aspect of the presently disclosed subject matter, the method for producing a light scattering sheet which is produced by forming, on a transparent support, a light scattering layer with a phase-separated convexo-concave structure formed by spinodal decomposition of a solution containing two or more resin materials capable of phase-separation from each other are dissolved in a solvent, the method comprising: a coating step for coating the transparent support with a solution containing a styrene-acrylonitrile copolymer as one of the resin materials to form a coating layer; a low speed drying step for drying the coating layer at room temperature in an initial drying of a section until the coating layer reaches a critical solid concentration for phase separation; and a high speed drying step for drying the coating layer after the initial drying at a drying rate of 1.5 g/m²·s or more, wherein the styrene-acrylonitrile copolymer is contained in the resin material composition of the coating layer to thereby suppress the nuclear growth of phase separation in the section of the initial drying so that the Marangoni number of the coating layer at the critical solid concentration for phase separation is less than 80.

Here, the resin materials may include monomers in addition to polymers. Further, drying the coating layer at room temperature in an initial drying of a section until the coating layer reaches a critical solid concentration for phase separation does not mean that the coating layer has to be dried at room temperature in the whole initial drying section. For example, the drying may be shifted to high speed drying before the critical solid concentration for phase separation is reached, as long as a light scattering sheet having stable optical properties can be obtained even if the drying at room temperature is completed before the coating layer reaches the critical solid concentration for phase separation. Namely, the reason for performing low speed drying at room temperature in the initial drying section is to prevent the variation of optical properties, particularly the values of transmitted image definition, of the light scattering sheet produced by rapid evaporation of a solvent from the coating layer when high speed drying is performed immediately after coating. Therefore, the drying may be shifted to high speed drying before the critical solid concentration for phase separation is reached, as long as a light scattering sheet having stable optical properties can be obtained even if the drying at room temperature is completed before the critical solid concentration for phase separation is reached.

Further, the critical solid concentration for phase separation refers to a solid concentration at which two or more resin materials constituting a coating layer start phase separation.

Further, “suppress the nuclear growth of phase separation”, “Marangoni number”, and “a method for determining the time it takes until the coating layer reaches the critical solid concentration for phase separation” in the above production method will be described below.

The present inventor has obtained a finding that the nuclear growth of phase separation can be suppressed so as to obtain a Marangoni number of less than 80 even if the coating layer is subject to low speed drying in the section of the initial drying by using a styrene-acrylonitrile copolymer as one of the resin materials, so that a random sea-island structure mainly having a string shape can be stably formed before rotating convection occurs due to the difference in temperature and difference in density between the upper and lower sides of the coating layer to form a regular liquid drop-like sea-island structure.

The production method of the presently disclosed subject matter has been made based on such a finding, wherein since a styrene-acrylonitrile copolymer is used as one of the resin materials, a phase-separated convexo-concave structure in which a plurality of domains have random shapes mainly having a string shape can be fainted even if a coating layer is subjected to low speed drying at room temperature in the initial drying section. Thereby, the produced light scattering sheet has a stable phase-separated convexo-concave structure having a transmitted image definition of 10% or more and less than 25%.

Further, the low speed drying at room temperature can prevent the occurrence of drying unevenness to stabilize the quality of optical properties. Then, the coating layer after the initial drying can be subjected to high speed drying at 1.5 g/m²·s or more to thereby quickly fix the formed phase-separated convexo-concave structure.

The resin materials preferably comprise the styrene-acrylonitrile copolymer, an acrylic resin, and a polyfunctional monomer, wherein the polyfunctional monomer is preferably a photopolymerizable acrylate monomer.

Further, in the production method of the presently disclosed subject matter, it is preferred that, in the low speed drying step, the temperature of drying air is set to room temperature, while the air velocity of the drying air is increased within the limit that drying unevenness does not occur. The air velocity of the drying air is, for example, preferably 1.5 m/s or more, more preferably 2.0 m/s or more.

This allows quick drying of a coating layer while forming an environment in which a difference in temperature is not easily produced between the upper and lower sides of the coating layer in the initial drying section. Thus, the coating layer can be dried at room temperature while suppressing the occurrence of rotating convection.

In the production method of the presently disclosed subject matter, it is effective to apply the presently disclosed subject matter in the case where the transparent support is triacetyl cellulose permeable to the solvent.

When a transparent support is permeable to a solvent like triacetyl cellulose, there is a possibility that the phase separation of a coating layer may advance by the permeation of the solvent into the transparent support to excessively develop a phase-separated convexo-concave structure. This will prevent a low image definition which is moire-eliminating performance from being achieved. Therefore, the presently disclosed subject matter is particularly effective when triacetyl cellulose is used as a transparent support because a light scattering sheet serves also as a protective sheet of a polarizing plate.

In the production method of the presently disclosed subject matter, the resin materials preferably comprise a styrene-acrylonitrile copolymer, an acrylic resin, and a polyfunctional monomer. The polyfunctional monomer is preferably a photopolymerizable acrylate monomer.

In the production method of the presently disclosed subject matter, the solvent is preferably a mixed solvent of a low boiling point solvent having a boiling point of less than 100° C. and a high boiling point solvent having a boiling point of 120° C. or higher.

A random sea-island structure mainly having a string shape can be further stably formed because the nuclear growth of phase separation can be suppressed by using a high boiling point solvent having a boiling point of 120° C. or higher in the mixed solvent. In this case, it is particularly preferred that the low boiling point solvent be methyl ethyl ketone, and the high boiling point solvent be cyclohexanone or methoxy propyl acetate.

In order to achieve an object as described above, there is provided a light scattering sheet according to another aspect of the presently disclosed subject matter, the light scattering comprising: a transparent support: and

a light scattering layer on the transparent support, the light scattering layer having a phase-separated convexo-concave structure formed by spinodal decomposition of a solution containing two or more resin materials capable of phase-separation from each other are dissolved in a solvent, wherein, in the light scattering layer, the phase-separated convexo-concave structure is formed into a sea-island structure of two or more resin materials including a styrene-acrylonitrile copolymer, and a plurality of domains constituting the islands have random shapes mainly having a string shape; and a transmitted image definition measured according to JIS K 7374 using an optical comb having a width of 2.0 mm is 10% or more and less than 25%.

Thus, a light scattering sheet having such optical properties can be produced by the production method mentioned above.

In the presently disclosed subject matter, since the phase-separated convexo-concave structure of a light scattering layer is formed into a sea-island structure of two or more resin materials including a styrene-acrylonitrile copolymer, the nuclear growth of phase separation when the phase-separated convexo-concave structure is formed can be suppressed. As a result, a random sea-island structure mainly having a string shape can be stably formed before rotating convection occurs due to the difference in temperature and difference in density between the upper and lower sides of the coating layer to form a regular liquid drop-like sea-island structure. Therefore, the resulting light scattering sheet has a transmitted image definition of 10% or more and less than 25% and is excellent in moire-eliminating performance.

The resin materials preferably comprise a styrene-acrylonitrile copolymer, an acrylic resin, and a polyfunctional monomer, and the polyfunctional monomer is preferably a photopolymerizable acrylate monomer.

In the light scattering sheet of the presently disclosed subject matter, the angular distribution of the transmitted light intensity is preferably a Gaussian distribution in the light scattering sheet.

High scattering properties can be obtained because the angular distribution of the transmitted light intensity in the light scattering sheet is a Gaussian distribution, and this can completely eliminate luminance unevenness and moire. When this is represented by specific numerical values, the light scattering sheet preferably has the phase-separated convexo-concave structure in which a proportion of region with a surface tilt angle in the range of 2.5° to 7.5° is 21% to 50%.

In the light scattering sheet of the presently disclosed subject matter, the transparent support is preferably formed of triacetyl cellulose permeable to the solvent. The reason is as described in the above production method.

In the light scattering sheet of the presently disclosed subject matter, the two or more resin materials preferably have different refractive indices.

According to the light scattering sheet and the method for producing the same of the presently disclosed subject matter, a light scattering sheet having a transmitted image definition of 10% or more and less than 25% and excellent in moire-eliminating performance can be produced, because a phase-separated convexo-concave structure in which a plurality of domains have random shapes mainly having a string shape can be stably formed even if a coating layer is subjected to low speed drying at room temperature in the initial drying of the coating layer, in producing the light scattering sheet by a phase separation method.

Further, a reduction in the thickness of a liquid crystal display device can be achieved by reducing the number of members by making the light scattering sheet serve also as a protective sheet of a polarizing plate because triacetyl cellulose can be used as the transparent support.

### BRIEF DESCRIPTION OF THE DRAWINGS

FIG. 1 is a laser reflection photomicrograph showing a phase-separated convexo-concave structure of the sheet surface of the light scattering sheet of the presently disclosed subject matter;

FIG. 2 is a diagram illustrating an example of a triangular phase diagram;

FIG. 3 is a diagram illustrating a method for measuring the drying rate of a coating layer;

FIG. 4 is a side view showing a suitable coating and drying apparatus in the production method of the light scattering sheet according to the presently disclosed subject matter;

FIG. 5 is a top view of the suitable coating and drying apparatus shown in FIG. 4;

FIG. 6 shows a modification of a coating and drying apparatus;

FIG. 7 is a top view of the coating and drying apparatus of FIG. 6;

FIG. 8 is a sectional view along the line 8-8 of THE coating AND drying apparatus of FIG. 6;

FIG. 9 is a table illustrating Test A of Examples of the presently disclosed subject matter;

FIG. 10 is a table illustrating Test B of Examples of the presently disclosed subject matter;

FIG. 11 is a table illustrating Test C of Examples of the presently disclosed subject matter;

FIG. 12 is a table illustrating Test D of Examples of the presently disclosed subject matter; and

FIG. 13 is a table illustrating Test E of Examples of the presently disclosed subject matter.

### DETAILED DESCRIPTION OF THE PREFERRED EMBODIMENTS

Hereinafter, the preferred embodiments of the light scattering sheet and the method for producing the same of the presently disclosed subject matter will be described in detail.

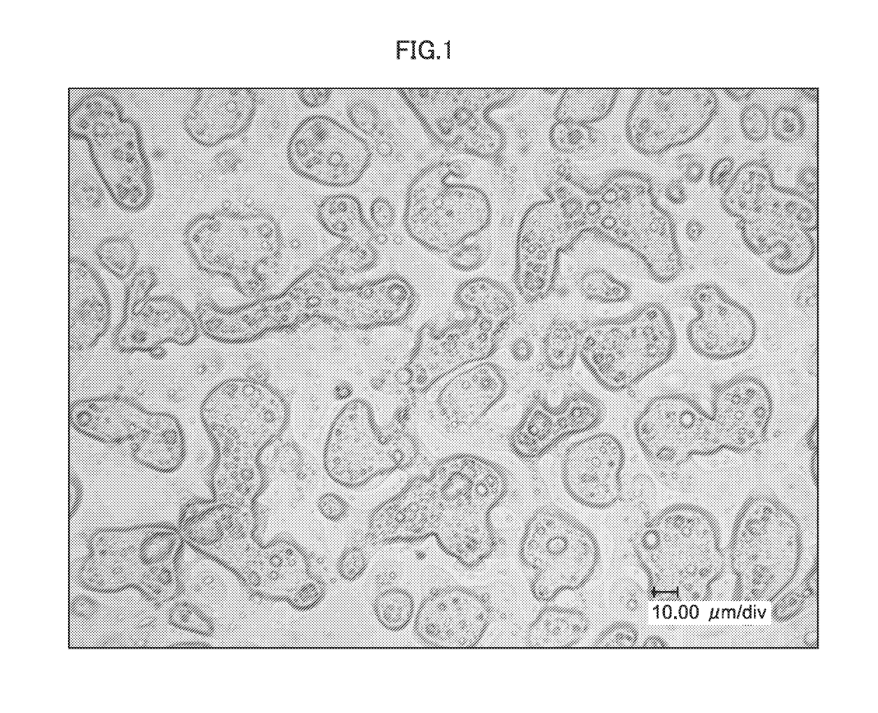

FIG. 1 is a laser reflection photomicrograph (magnification 5×) of the light scattering sheet of the presently disclosed subject matter.

As shown in the photomicrograph of FIG. 1, the phase-separated convexo-concave structure of the light scattering sheet is formed into a sea-island structure of two or more resin materials, in which a plurality of domains constituting the islands have random shapes mainly having a string shape. That is, the phase-separated convexo-concave structure is formed into a random structure in which a plurality of string-shaped domains is arranged being tangled with each other. This provides a phase-separated convexo-concave structure suitable for eliminating moire in that the structure has good light scattering properties and does not have a large sea even though the convexo-concaves on the sheet surface by phase separation is large.

Specifically, the light scattering sheet of the presently disclosed subject matter having a phase-separated convexo-concave structure shown in FIG. 1 can be produced by a method for producing a light scattering sheet comprising, formed on a transparent support, a light scattering layer with a phase-separated convexo-concave structure formed by spinodal decomposition of a solution containing two or more resin materials capable of phase-separation from each other are dissolved in a solvent, the method including: a coating step for coating the transparent support with a solution containing a styrene-acrylonitrile copolymer as one of the resin materials to form a coating layer; a low speed drying step for drying the coating layer at room temperature in an initial drying of a section until the coating layer reaches a critical solid concentration for phase separation; and a high speed drying step for drying the coating layer after the initial drying at a drying rate of 1.5 g/m²·s or more, wherein the styrene-acrylonitrile copolymer is contained in the resin material composition of the coating layer to thereby suppress the nuclear growth of phase separation in the section of the initial drying so that the Marangoni number of the coating layer is less than 80 at the critical solid concentration for phase separation.

Further, although it is necessary to include a styrene-acrylonitrile copolymer as one of the two or more resin materials capable of phase-separation from each other, a polymer and a monomer can be used as other resin materials. For example, a resin material comprising a styrene-acrylonitrile copolymer, an acrylic resin, and a polyfunctional monomer can be suitably used, wherein the polyfunctional monomer is preferably a photopolymerizable acrylate monomer.

Here, “suppress the nuclear growth of phase separation”, “Marangoni number”, and “a method for determining the time until the coating layer reaches the critical solid concentration for phase separation” used in the method for producing a light scattering sheet as described above will be described.

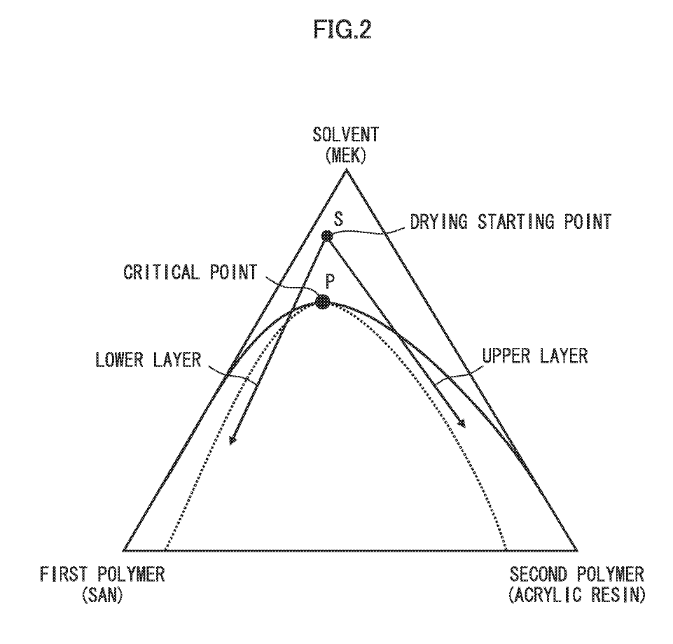

FIG. 2 shows an example of a triangular phase diagram illustrating the phase separation of a solution containing three components: a first polymer and a second polymer capable of phase-separation from each other and a solvent which dissolves these polymers. This is the case where the first polymer is a styrene-acrylonitrile copolymer (SAN), the second polymer is an acrylic resin, and the solvent is methyl ethyl ketone.

In FIG. 2, the solid curve shows a binodal line, which is a boundary line on which phase separation occurs, and the dotted curve shows a spinodal line. Phase separation occurs in the region inside the binodal line. The region surrounded by the binodal line and the spinodal line is called a metastable region, and phase separation advances by nucleation or a growth mechanism. The region inside the spinodal line is an unstable region, where phase separation by spinodal decomposition occurs. The point at which the binodal line is brought into contact with the spinodal line is the critical point P at which phase separation by spinodal decomposition starts.

This critical point P can be determined based on a literature (CORNELL UNIVERSITY PRESS, “Scaling Concepts in Polymer Physics”, pp. 94 to 96), for example.

Further, “suppress the nuclear growth of phase separation” refers to reducing the time it takes to reach the above unstable region where spinodal decomposition for forming the phase-separated convexo-concave structure in the presently disclosed subject matter is performed by reducing the time to pass through the above metastable region when the ratio of the above three components moves in the direction of the arrow in the triangular phase diagram of FIG. 2 from the drying starting point S as the drying of the coating layer proceeds.

In this case, the following two methods A and B are available to reduce the time to pass through the metastable region.

In the method A, the direction of the arrow from the drying starting point S passes through the vicinity of the critical point P so that the route crossing the metastable region is shortened.

In the method B, the coating layer is subject to high speed drying to dry it at a stroke when the coating layer has reached a critical solid concentration for phase separation at which phase separation is started, thereby reducing the time crossing the metastable region.

In the production method of a light scattering sheet of the presently disclosed subject matter, the above method B has been employed, so that even when the coating layer is subjected to low temperature drying at room temperature in the initial drying until the coating layer reaches a critical solid concentration for phase separation, the nuclear growth of phase separation is suppressed by subjecting the coating layer to high speed drying at a drying rate of 1.5 g/m²·s or more after the critical solid concentration for phase separation is reached.

Further, the time until the solid concentration of the coating layer 16A reaches the critical solid concentration for phase separation can be determined from the above triangular phase diagram by determining the drying time until the coating layer reaches the critical solid concentration from the critical solid concentration which is the solid concentration of the coating layer at the critical point P and the drying condition (drying rate).

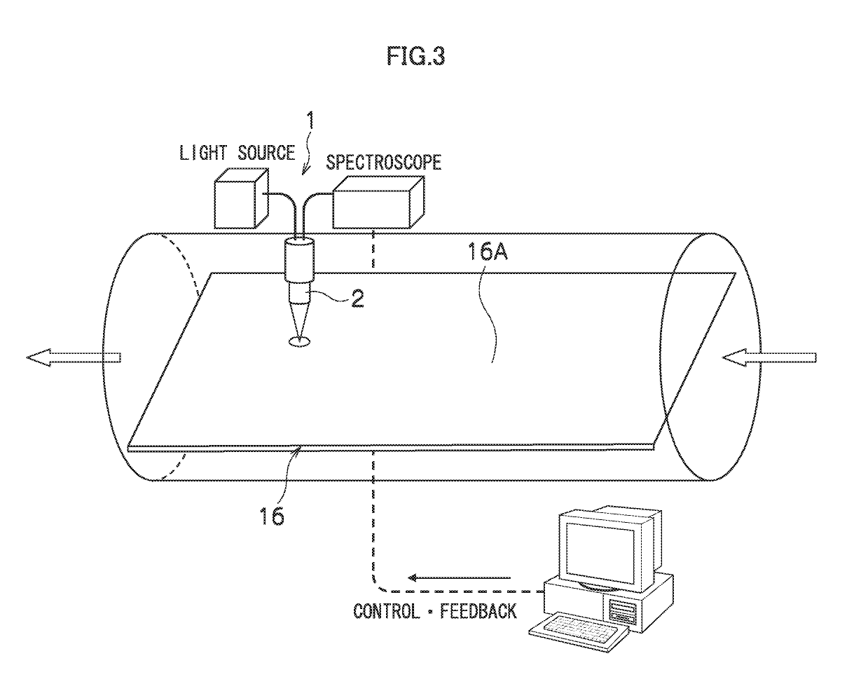

The drying rate (drying speed) of the coating layer can be measured with a portable type FTIR (Fourier Transform Infrared Spectroscopy) apparatus 1 as shown in FIG. 3, for example. That is, as shown in FIG. 3, the change with time of the amount of evaporated solvent in the coating layer accompanying drying can be examined by measuring the absorbance change from the top of a coating layer 16A of a transparent support 16 travelling in the direction of the arrow using a portable type FTIR apparatus 1 having a sensor part 2 made of fibers. As the FTIR apparatus 1, VIR-9500 manufactured by JASCO Corporation can be used, for example.

Further, the Marangoni number (Ma) can be represented by the following formula:

Ma=(t/μκ)*|δσ/δT|*ΔT

Note that in the above formula, each symbol denotes the following:

t: Layer thickness of a coating layer (m),

μ: Viscosity of a coating liquid (N·s/m²),

κ: Thermal conductivity (W/m·K),

|δσ/δT|: Temperature gradient of surface tension (N/m·K), and

ΔT: Temperature difference between the front surface and the back surface of a coating layer (K).

In addition, a Marangoni number (Ma) of 80 is the critical point at which Marangoni convection occurs during the drying of a coating layer, and if the Marangoni number (Ma) is less than 80, the Marangoni convection will not occur.

Further, in the method for producing a light scattering sheet of the present embodiment, the upper limit of the drying rate in the high speed drying step is the limit in which drying unevenness does not occur, and is preferably 20 g/m²·s or less, for example.

The method for producing the light scattering sheet of the presently disclosed subject matter includes drying a coating layer at room temperature in an initial drying of a section until the coating layer reaches a critical solid concentration for phase separation and subjecting the coating layer to high speed drying at a drying rate of 1.5 g/m²·s or more after the completion of the initial drying. In this case, in the low speed drying step, the temperature of a drying air is set to room temperature, while the air velocity of the drying air is preferably increased within the limit that drying unevenness does not occur. This allows quick drying while forming an environment in which a difference in temperature is not easily produced between the upper and lower sides of the coating layer, so that the occurrence of rotating convection in the coating layer can be suppressed. The air velocity is, for example, preferably 1.5 m/s or more, more preferably 2.0 m/s or more. If wind unevenness occurs in the coating layer with the increase in the drying air velocity, a surfactant or the like may be added to the coating liquid. This allows a Marangoni number of the coating layer of less than 80 to be achieved more positively at the critical solid concentration for phase separation.

Further, in the high speed drying in the high speed drying step, the temperature of the drying air is maintained at the boiling point of a solvent or higher and 130° C. or less, while the drying rate in the above high speed drying step is preferably achieved by increasing the air velocity of the drying air. This is for preventing the optical properties as a polarizing plate protective film from being degraded by the production of wrinkles due to drying heat even if the coating layer is subjected to high speed drying using triacetyl cellulose as the transparent support 16.

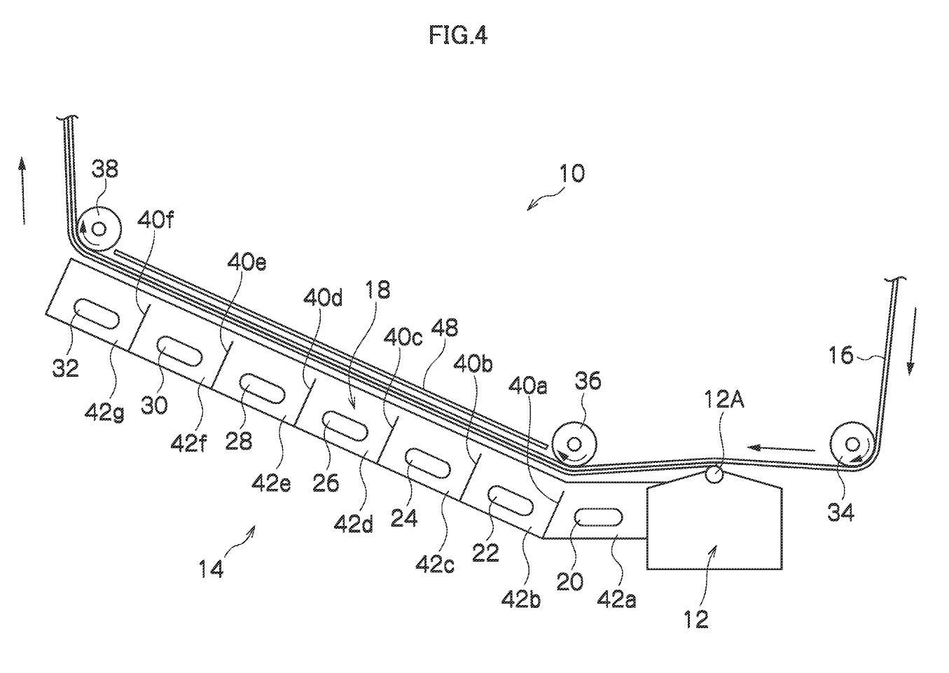

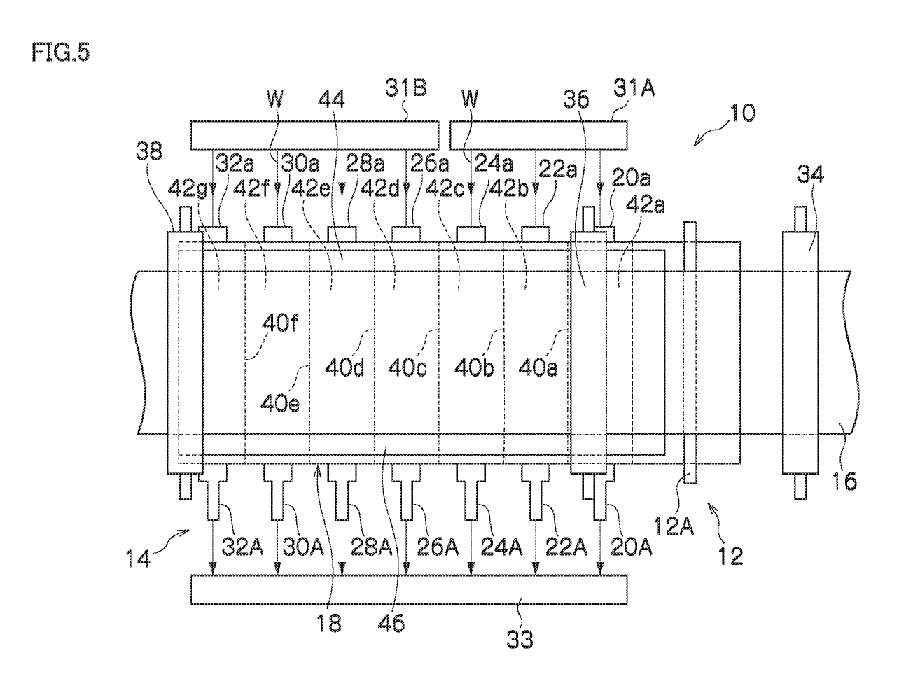

FIG. 4 is a side view of an example of a coating and drying apparatus 10 suitable for coating and drying in the method for producing the light scattering sheet of the presently disclosed subject matter, and FIG. 5 is a top view of FIG. 4 shown with a shield to be described below removed.

As shown in FIGS. 4 and 5, the coating and drying apparatus 10 mainly comprises a coating machine 12 for applying a coating liquid for a light scattering sheet (hereinafter referred to as a coating liquid) to a continuously traveling band-shaped transparent support 16 to form a coating layer 16A on the transparent support 16, a dryer 14 for passing the transparent support 16 through a plurality of drying zones 42a to 42g formed in the dryer body 18 to dry the coating layer 16A, and one-way air flow generating devices 20, 22, 24, 26, 28, 30, and 32 for generating one-way flow drying air W flowing from one side to the other side in the width direction of the transparent support in each of the drying zones 42a to 42g.

The present embodiment is the case where, for the drying zones 42a to 42g, drying zones 42a to 42c in the first portion are used as a low speed drying zone, and drying zones 42d to 42g in the second portion are used as a high speed drying zone. Therefore, the drying air at room temperature is blown from the one-way air flow generating devices 20 to 24 corresponding to the drying zones 42a to 42c in the first portion, and the drying air at the evaporating temperature of a solvent or higher and 130° C. or less is blown from the one-way air flow generating devices 25 to 32 corresponding to the drying zones 42d to 42g in the second portion. Note that the range of the low speed drying zone used among the drying zones 42a to 42g can be arbitrarily set within the limit until the coating layer 16A reaches the critical solid concentration for phase separation. Namely, even if the drying zones 42a to 42c are set as a zone for initial drying, the initial drying zone can be changed, for example, to the drying zones 42a to 42b or to only the drying zone 42a, as long as a light scattering sheet having stable optical properties (particularly, stable general transmitted image definition) can be obtained even when the low speed drying is completed before the coating layer 16A reaches the critical solid concentration for phase separation.

So that the coating layer 16A applied in the coating machine 12 may be first dried at room temperature in the dryer 14 immediately after coating, it is preferred to set the distance between the coating machine 12 and the dryer 14 and the travelling speed of the transparent support 16 so that the time from the completion of coating to the start of drying is 10 seconds or less, preferably 5 seconds or less, particularly preferably 1 second or less.

Note that although the present embodiment is described with the example of the coating and drying apparatus 10 in which the coating machine 12 and the dryer 14 are integrated, the coating machine 12 and the dryer 14 may be separately installed so that the coating layer is air dried at room temperature on the transportation line of the transparent support 16 from the coating machine 12 to the dryer 14.

As the coating machine 12, a bar coater provided with a wire bar 12A can be used, for example, in which the coating liquid is applied to the bottom of the transparent support 16 traveling supported by a plurality of pass rollers 34, 36, and 38 to form the coating layer 16A. FIGS. 4 and 5 show a drawing of a wire bar coating machine as an example of the coating machine 12, but the coating machine 12 is not limited to the wire bar coating machine.

The transparent support 16 which can be suitably used includes a cellulose resin (for example, triacetyl cellulose: TAC), a polyester resin (for example, polyethylene terephthalate: PET), a polysulfone resin (for example, polysulfone), and a cyclic polyolefin resin (for example, ARTON (trademark) supplied from JSR Corporation).

In particular, when the produced light scattering sheet serves also as a polarizing plate protective sheet on the backlight side, triacetyl cellulose which is reduced in optical anisotropy such as phase difference is preferably used as the transparent support 16.

Further, a solvent of the coating liquid which can be suitably used includes, but is not limited to, a mixed solvent of a low boiling point solvent having a boiling point of less than 100° C. and a high boiling point solvent having a boiling point of 120° C. or higher. Thus, since the nuclear growth of phase separation can be suppressed by using a high boiling point solvent having a boiling point of 120° C. or higher in the mixed solvent, it is possible to further stably form a random sea-island structure mainly having a string shape. In this case, it is particularly preferred that the low boiling point solvent be methyl ethyl ketone, and the high boiling point solvent be cyclohexanone or methoxy propyl acetate.

The dryer body 18 is provided immediately after the coating machine 12 and formed into a rectangular box-shape along the coating film surface side (bottom side of the transparent support 16) of the traveling transparent support 16, and, of the surfaces of the box, the surface of the box on the coating layer surface side (upper surface of FIG. 4) is cut. Thereby, a drying zone having a U-shaped cross section which surrounds the coating layer 16A applied to the traveling transparent support 16 is formed. The drying zone is divided into a plurality of drying zones 42a, 42b, 42c, 42d, 42e, 42f, and 42g (an example of seven divided zones are shown in the present embodiment, but divided zones are not limited to the example) by dividing the dryer body 18 with a plurality of divider plates 40a to 40f provided perpendicularly to the traveling direction of the transparent support 16. In this case, the distance between the upper end of the divider plates 40a to 40f dividing the drying zones 42a to 42g and the surface of the coating layer is preferably in the range of 0.5 mm to 12 mm, more preferably in the range of 1 mm to 10 mm. Further, one-way air flow generating devices 20 to 32 (refer to FIG. 5) are provided in each of the drying zones 42a to 42g.

As shown in FIG. 5, the one-way air flow generating devices 20 to 32 mainly comprises suction ports 20a, 22a, 24a, 26a, 28a, 30a, and 32a formed on one side of the both sides of the dryer body 18, exhaust ports 20A, 22A, 24A, 26A, 28A, 30A, and 32A formed on the other side opposing the suction ports 20a to 32a, a drying air temperature adjustment device 31 connected to each of the suction ports 20a to 32a, and an exhaust device 33 connected to each of the exhaust ports 20A to 32A.

As shown in FIG. 5, the drying air temperature adjustment device 31 is divided into a low speed drying temperature adjustment device 31A which performs low speed drying and a high speed drying temperature adjustment device 31B which performs high speed drying, and is connected to the suction ports 20a to 32a of the respective drying zones. Further, the high speed drying temperature adjustment device 31B is configured so that the temperature of the drying air supplied to each of the suction ports 26a to 32a can be adjusted for each drying zone. Thus, the drying air W having a predetermined temperature sucked into each of the drying zones 42a to 42g from the suction ports 20a to 32a is exhausted from the exhaust ports 20A to 32A by driving the exhaust device 33, so that the drying air W flowing one way from one side (suction port side) to the other side (exhaust port side) in the width direction of the transparent support in each of the drying zones 42a to 42g is produced. These one-way air flow generating devices 20 to 32 are configured to be capable of individually controlling the exhaust volume (air velocity) for each of the drying zones 42a to 42g by the exhaust device 33.

The drying air W sucked from the suction ports 20a to 32a is preferably air-conditioned air in which humidity in addition to temperature is air-conditioned. It is also preferred to control to the drying air W sucked from the suction ports 20a to 32a so that it contains a predetermined concentration of solvent gas of the coating liquid.

Further, the width of the dryer body 18 is preferably formed to be larger than the width of the transparent support 16 so as to provide an air straightening part in which open parts at both sides of the drying zones 42a to 42g are covered with cover plates 44 and 46. The air straightening part ensures the distance from the suction ports 20a to 32a to one end of the coating layer in the width direction and the distance from the other end of the coating layer in the width direction to the exhaust ports 20A to 32A, and allows the drying air W to be easily sucked into the drying zones 42a to 42g only from the suction ports 20a to 32a. This prevents the flow other than the one-way flow drying air W in the width direction of the transparent support from being generated in the drying zones 42a to 42g. The length of the air straightening part, that is, cover plates 44 and 46, is preferably in the range of 50 mm or more and 150 mm or less, for both the suction port side and exhaust port side.

Besides the above cover plates 44 and 46, the position of the wire bar 12A of the coating machine 12 and the position of the pass roller 36 are preferably configured so that the transparent support 16 travels closest to the drying zone 42a as if the open part of the drying zone 42a is covered with the transparent support 16. Further, a shield 48 (refer to FIG. 4) is preferably provided on the opposite side position to the dryer body 18 with the transparent support 16 sandwiched in between so that the stable traveling of the transparent support 16 may not be inhibited by winds such as the above air conditioned wind.

The coating and drying apparatus 10 configured as described above allows the coating layer in the initial drying to be dried at room temperature and the coating layer after the initial drying to be dried at a drying rate of 1.5 g/m²·s or more. Moreover, the one-way flow drying air W is blown from the direction parallel to the surface of the transparent support 16 and perpendicular to the traveling direction of the support, so that drying unevenness hardly occurs even if the air velocity is increased.

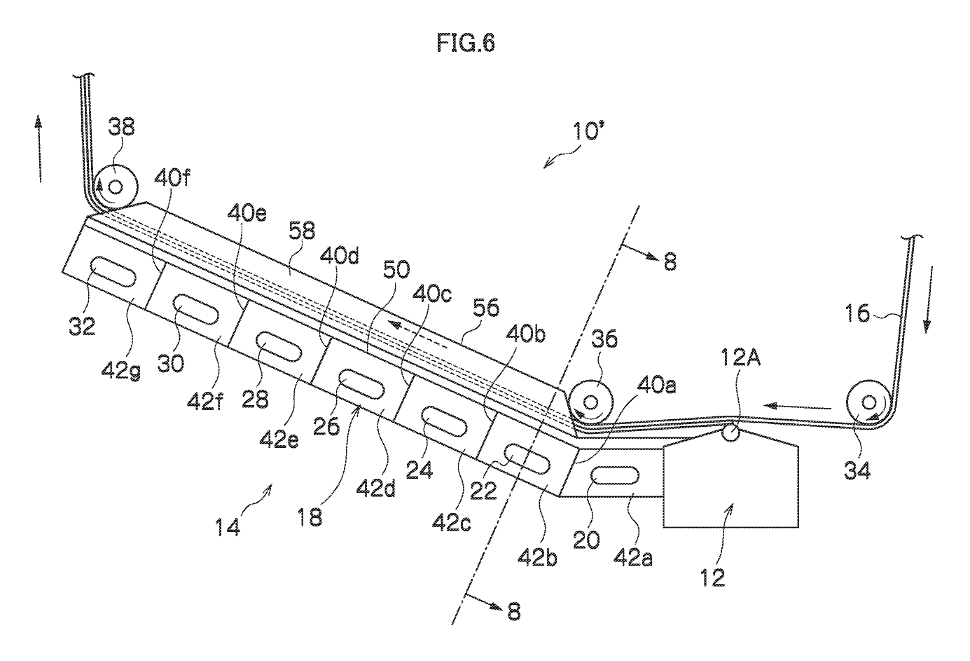

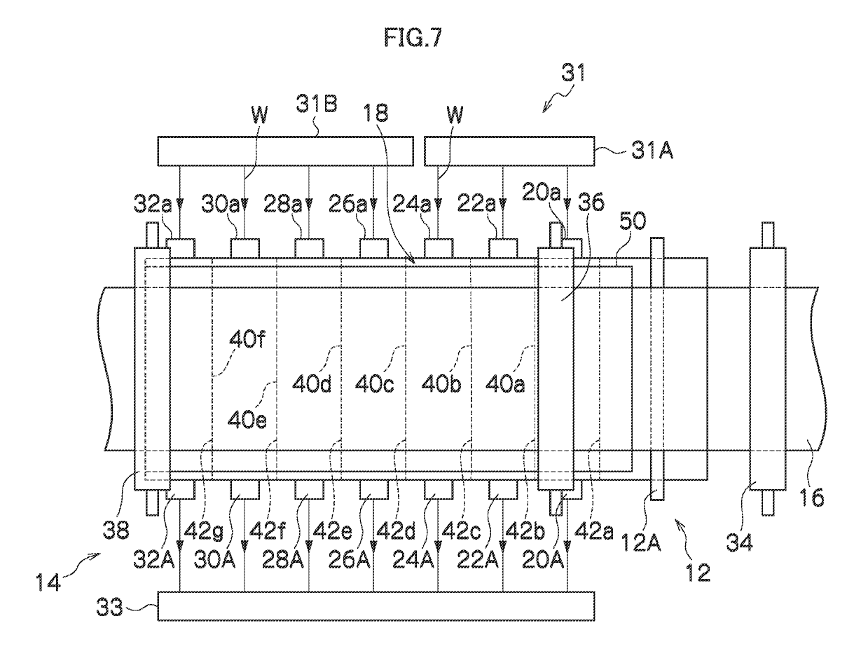

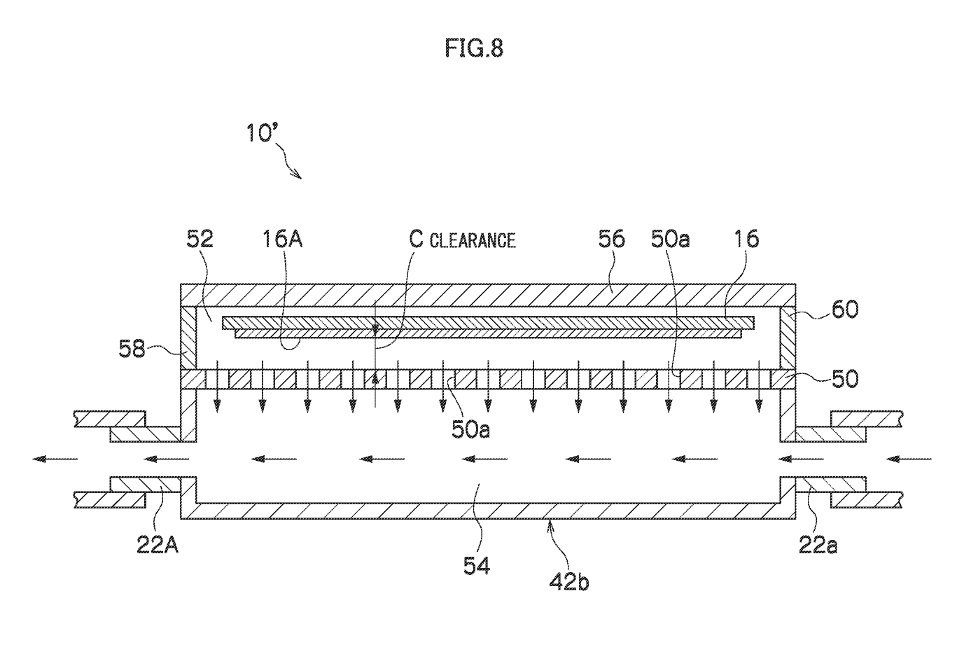

FIG. 6 is a side view showing a modification 10′ of the coating and drying apparatus 10 shown in FIGS. 4 and 5, and FIG. 7 is a top view of the coating and drying apparatus 10′ shown in FIG. 6. In addition, FIG. 8 shows a sectional view along the line 8-8 in FIG. 6, illustrating a principal part of the dryer body 18 which is a characterizing portion of the modification of FIG. 6. Note that FIG. 7 shows the coating and drying apparatus 10′ with a top cover to be described below removed.

The dryer 14 of the coating and drying apparatus 10 described in FIGS. 4 and 5 is an embodiment in which the one-way flow drying air W towards the exhaust ports 20A to 32A from the suction ports flows in contact with the surface of the coating layer 16A applied to the transparent support 16. On the other hand, the coating and drying apparatus 10′ in a modification to be described below is an embodiment in which the one-way flow drying air W is not in direct contact with the surface of the coating layer 16A.

Note that since FIGS. 6 and 7 are basically the same as FIGS. 4 and 5 as described above, the explanation thereof is omitted and the same reference numerals are used to denote the same members.

FIG. 8 shows a sectional view along the line 8-8 in the direction perpendicular to the traveling direction of the transparent support 16 for the second-step drying zone 42b among the seven-part divided drying zones 42a to 42g. Other drying zones are the same.

The drying zone 42b is provided with an air straightening plate 50 which has a surface parallel to the transparent support 16 and a large number of pores 50a. The opening ratio of the air straightening plate 50 and a material thereof are not particularly limited, but a wire net, a punching metal, or the like each having an opening ratio of 50% or less is preferred, and the opening ratio is more preferably 20% to 40%. Specifically, a 300-mesh wire net having an opening ratio of 30% can be used.

The drying zone 42b is divided by the air straightening plate 50 into a passage chamber 52 through which the transparent support 16 is passed and an exhaust chamber 54 through which the solvent evaporated from the coating layer 16A by the one-way flow drying air W flowing in the width direction of the transparent support 16 is exhausted. The exhaust chamber 54 is provided with a suction port 22a and an exhaust port 22A, and the exhaust port 22A is connected to the exhaust device 33.

If the clearance between the coating layer 16A applied to the transparent support 16 and the air straightening plate 50 is large, an eddy of the drying air W will occur to cause the occurrence of drying unevenness on the surface of the coating layer 16A. Then, in order to control the flow of the drying air W, the clearance C between the coating layer 16A and the air straightening plate 50 is preferably 3 mm to 30 mm, more preferably 5 mm to 15 mm. Further, a top cover 56 and side seals 58 and 60, which are sealing members, are attached to suppress the flow of the unnecessary air from the back surface (surface on which the coating film is not formed) and the sides of the transparent support 16.

According to the configuration of the dryer 14 in the coating and drying apparatus 10′ of the above modification, the solvent gas evaporated from the coating layer 16A is pulled by the one-way flow drying air W flowing in the width direction of the transparent support 16, passes through the pores 50a of the air straightening plate 50, enters into the exhaust chamber 54, and is discharged from the exhaust port 22A to the outside of the drying zone 42b.

Therefore, since the surface of the coating layer 16A is not directly exposed to the drying air W, drying unevenness will not easily occur even if the air velocity of the one-way flow drying air W flowing from the suction port to the exhaust port is set higher than that in the dryer shown in FIGS. 2 and 3.

Thus, according to the method for producing a light scattering sheet of the present embodiment, a phase-separated convexo-concave structure in which a plurality of domains have random shapes mainly having a string shape can be formed even if the coating layer is subjected to low speed drying at room temperature in the initial drying of the coating layer, in producing the light scattering sheet by a phase separation method. This allows a light scattering sheet having a transmitted image definition of 10% or more and less than 25% and excellent in moire-eliminating performance to be produced.

Further, in the presently disclosed subject matter, since it is not necessary to carry out high speed drying immediately after coating, the occurrence of drying unevenness can be prevented to stabilize the quality of optical properties.

As a result, the shape of the domains formed from the phase separation is not regular spiral domains but random string-shaped domains as described in FIG. 1, and the distribution of domains also has an irregular phase-separated convexo-concave structure.

Further, in the method for subjecting the coating layer to low speed drying and high speed drying, the one-way flow drying air W is blown from the direction parallel to the surface of the transparent support 16 and perpendicular to the traveling direction of the support, so that drying unevenness hardly occurs even if the air velocity is increased. In particular, if the drying temperature is increased to achieve high speed drying when moving from low speed drying to the high speed drying in the middle of the initial drying period in which the solvent concentration of the coating layer is high, a variation in the optical properties, particularly transmitted image definition, accompanying the drying unevenness by rapid evaporation of the solvent may be produced. However, like in the present embodiment, the drying unevenness can be prevented by not increasing the temperature of the drying air but by increasing the air velocity of the one-way flow drying air. Further, even if the coating layer 16A is subjected to high speed drying using triacetyl cellulose as the transparent support 16, optical properties as a polarizing plate protective film will not be degraded by the production of wrinkles in the transparent support 16 due to drying heat.

Finally, the coating layer 16A after the coating and drying is sent to a curing step, in which the coating layer is cured.

In the presently disclosed subject matter, the curing method for curing the coating layer 16A of a light scattering sheet preferably includes curing through crosslinking reaction or polymerization reaction by light irradiation, electron beam irradiation, or heating of a coating layer containing an ionizing radiation-curable compound. In this case, the curing is preferably performed in an atmosphere having an oxygen concentration of 10% by volume or less. An outermost layer excellent in physical strength and chemical resistance can be obtained by forming it in an atmosphere having an oxygen concentration of 10% by volume or less. The oxygen concentration is preferably 5% by volume or less, more preferably 1% by volume or less, particularly preferably 0.5% by volume or less, and most preferably 0.1% by volume or less.

A technique of reducing the oxygen concentration to 10% by volume or less includes replacing the atmospheric air (having a nitrogen concentration of about 79% by volume and an oxygen concentration of about 21% by volume) with another gas, particularly preferably with nitrogen (nitrogen purge).

The light source for light irradiation may include any light source having a wavelength in the ultraviolet light region or near infrared ray region, and the light source of ultraviolet light includes an ultra-high pressure, high pressure, moderate pressure, or low pressure mercury lamp, a chemical lamp, a carbon-arc lamp, a metal halide lamp, a xenon lamp, and sunlight. Various available laser light sources having a wavelength of 350 to 420 nm may be converted to multibeams before irradiation.

Further, the near infrared light source includes a halogen lamp, a xenon lamp, and a high pressure sodium lamp, and various available laser light sources having a wavelength of 750 to 1400 nm may be converted to multibeams before irradiation.

When using the near infrared light source, it may be used in combination with an ultraviolet ray source, or light irradiation may be performed from the base material surface side opposite to the coated surface side. Thereby, the film curing in the depth direction of the coating layer advances without delay relative to the vicinity of the surface, and a cured film in a uniformly cured state is obtained.

The irradiation intensity of the ultraviolet rays with which the coating layer is irradiated is preferably about 0.1 to 1000 mW/cm², and the amount of light irradiation on the surface of the coating layer is preferably 10 to 1000 mJ/cm². Further, the temperature distribution of the coating layer during the light irradiation is preferably as uniform as possible, and the temperature distribution is preferably controlled within ±3° C., more preferably within ±1.5° C. This temperature range is preferred because the polymerization reaction advances uniformly in the surface and in the depth direction of the layer of the coating layer 16A.

The light scattering sheet of the presently disclosed subject matter can have high light scattering properties to effectively prevent the occurrence of luminance unevenness or moire by performing the coating step, drying step, and curing step as described above, and a reduction in the thickness of a liquid crystal display device can be achieved by reducing the number of members because the light scattering sheet can also serve as a protective sheet of a polarizing plate by using triacetyl cellulose as a support.

The light scattering sheet of the presently disclosed subject matter obtained through the above coating step, drying step, and curing step has the following optical properties. Specifically, the transmitted image definition is 10% or more and less than 25%, and the haze is 20 to 60%. In addition, the proportion of the surface tilt angle in the range of 2.5° to 7.5° of the phase-separated convexo-concave structure formed in the light scattering sheet is 21% to 50%; the surface roughness Ra is 0.3 μm or more; and the area ratio in the convex part of string-shaped domains is 50% or less.

### Example 1

The features of the presently disclosed subject matter will now be more specifically described with reference to Examples, but the scope of the presently disclosed subject matter shall not be construed to be limited by specific examples described below.

### [Test A]

In Test A, a light scattering sheet was produced using five types of coating liquids for light scattering having the following composition, and then the transmitted image definition (%), the proportion (%) of the surface tilt angle in the range of 2.5 to 7.5°, and the degree of moire elimination were examined.

### (Types of Coating Liquid for Light Scattering)

Five types of coating liquid for light scattering comprising the following resin materials and solvent were prepared.

<Coating liquid A-1>

| | |
|---|---|
| Acrylic resin | 17.9 g |
| Styrene-acrylonitrile copolymer (SAN) | 2.4 g |
| Dipentaerythritol hexaacrylate | 18.3 g |
| IRGACURE 184 (trademark) supplied | |
| from BASF Schweiz AG | 1.4 g |
| Methyl ethyl ketone | 30.0 g |
| Methoxy propyl acetate | 30.0 g |

<Coating liquid A-2>

| | |
|---|---|
| Acrylic resin | 17.9 g |
| Cellulose acetate propionate (CAP) | 2.4 g |
| Dipentaerythritol hexaacrylate | 18.3 g |
| IRGACURE 184 | 1.4 g |
| Methyl ethyl ketone | 30.0 g |
| Methoxy propyl acetate | 30.0 g |

<Coating liquid A-3>

| | |
|---|---|
| Acrylic resin | 17.9 g |
| Polyester (VYLON 200(trademark) | 2.4 g |
| supplied from TOYOBO Co. Ltd.) | |
| Dipentaerythritol hexaacrylate | 18.3 g |
| IRGACURE 184 | 1.4 g |
| Methyl ethyl ketone | 30.0 g |
| Methoxy propyl acetate | 30.0 g |

<Coating liquid A-4>

| | |
|---|---|
| Acrylic resin | 17.9 g |
| Polyester Urethane (VYLON UR-1400 | 2.4 g |
| (trademark) supplied from TOYOBO Co. Ltd.) | |
| Dipentaerythritol hexaacrylate | 18.3 g |
| IRGACURE 184 | 1.4 g |
| Methyl ethyl ketone | 30.0 g |
| Methoxy propyl acetate | 30.0 g |

<Coating liquid A-5>

| | |
|---|---|
| Acrylic resin | 17.9 g |
| Polymethylmethacrylate (PMMA) | 2.4 g |
| Dipentaerythritol hexaacrylate | 18.3 g |
| IRGACURE 184 | 1.4 g |
| Methyl ethyl ketone | 30.0 g |
| Methoxy propyl acetate | 30.0 g |

Triacetyl cellulose (Fujitac, manufactured by Fuji Photo Film Co., Ltd.) having a width of 1000 mm and a thickness of 80 μm was used as a transparent support.

### (Coating and Drying Conditions)

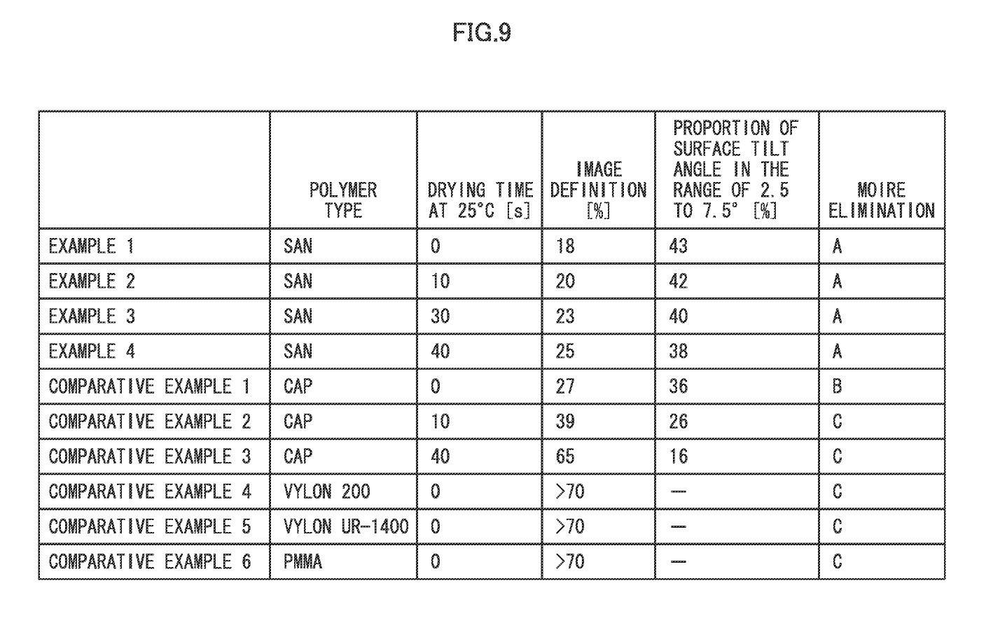

The above five types of coating liquid were continuously applied by a die coating method using a slot die described in Example 1 of Japanese patent application Laid-Open No. 2006-122889 to form coating layers each having a film thickness of 10.5 μm. Next, the resulting coating layers were each subjected to low speed drying at room temperature (25° C.) for a period of time shown in FIG. 9 and then subjected to high speed drying (the drying rate corresponds to 2.05 g/m²·s) at 100° C. for one minute. Thus, light scattering sheet samples in Examples 1 to 4 and Comparative Examples 1 to 6 were prepared.

Then, the coating layer of each sample was irradiated with ultraviolet rays having an illumination of 600 mW for 4 seconds using an ultraviolet irradiation apparatus (ultraviolet lamp 32: output 160 W/cm, luminescence length 1.6 m) to subject the coating layer to crosslinking reaction to cure the same.

The coating liquid composition and the slow speed drying condition of each sample are as follows.

Example 1: The coating liquid A-1 was used to form a coating layer, which was subjected to high speed drying immediately after coating (low speed drying for zero second).

Example 2: The coating liquid A-1 was used to form a coating layer, which was subjected to low speed drying for 10 seconds and then subjected to the above high speed drying.

Example 3: The coating liquid A-1 was used to form a coating layer, which was subjected to low speed drying for 30 seconds and then subjected to the above high speed drying.

Example 4: The coating liquid A-1 was used to foam a coating layer, which was subjected to low speed drying for 40 seconds and then subjected to the above high speed drying.

Comparative Example 1: The coating liquid A-2 was used to form a coating layer, which was subjected to high speed drying immediately after coating.

Comparative Example 2: The coating liquid A-2 was used to form a coating layer, which was subjected to low speed drying for 10 seconds and then subjected to the above high speed drying.

Comparative Example 3: The coating liquid A-2 was used to form a coating layer, which was subjected to low speed drying for 40 seconds and then subjected to the above high speed drying.

Comparative Example 4: The coating liquid A-3 was used to form a coating layer, which was subjected to high speed drying immediately after coating.

Comparative Example 5: The coating liquid A-4 was used to form a coating layer, which was subjected to high speed drying immediately after coating.

Comparative Example 6: The coating liquid A-5 was used to form a coating layer, which was subjected to high speed drying immediately after coating.

Then, each of the light scattering sheet samples produced as described above was used to prepare a polarizing plate as follows.

### (Preparation of a Polarizing Plate)

Polyvinyl alcohol was allowed to adsorb iodine and stretched to prepare a polarizing film. Then, each of the light scattering sheet samples prepared as described above (Examples 1 to 4, Comparative Examples 1 to 6) was stuck to the backlight side of the polarizing film, and a triacetyl cellulose film (Fujitac, manufactured by Fuji Photo Film Co., Ltd.) having a thickness of 80 micrometers was stuck to the opposite surface of the polarizing film. The triacetyl cellulose film was immersed in aqueous NaOH solution of 1.5 mol/L and 55° C. for two minutes, and then neutralized and washed with water, before using. Thus, polarizing plates were prepared.

The light scattering sheets and the polarizing plates prepared as described above were evaluated as follows.

### [Evaluation Method of Light Scattering Sheets and Polarizing Plates]

The above light scattering sheet samples were evaluated for the following items. The results are shown in the table of FIG. 9.

### (1) Transmitted Image Definition (Image Definition)

The image definition (%) of a light scattering sheet was measured according to JIS K7105 (1999 edition) using ICM-1T manufactured by Suga Test Instruments Co., Ltd. Here, the image definition in the presently disclosed subject matter was specified as a value in the case of measurement with an optical comb of 2.0 mm. Note that the image definition is preferably 10% or more and less than 25%.

### (2) Tilt Angle Distribution Profile (Proportion of the Surface Tilt Angle in the Range of 2.5° to 7.5°)

The prepared light scattering sheets were subjected to measurement using an SXM520-AS150 type manufactured by Micromap Corporation (United State). A halogen lamp in which an interference filter having a center wavelength of 560 nm was inserted was used as a light source. The magnification of an objective lens is 10× (10 times power), and data was incorporated by a ⅔-inch CCD (Charge Coupled Device) having a number of pixels of 640×480. Thus, the measuring pitch in the longitudinal direction and the transverse direction was 1.3 micrometers, the measurement unit of the tilt angle was 0.8 square micrometers, and the measurement range was 500000 square micrometers (0.5 square millimeter). Further, the tilt angle was calculated from the height data of three points which are measurement units, and the average tilt angle and the proportion of the surface tilt angle in the range of 2.5° or more and 7.5° or less were determined from the total measurement data. Note that the proportion of the surface tilt angle in the range of 2.5° to 7.5° of the phase-separated convexo-concave structure is preferably in the range of 21% to 50%.

### (3) Light Scattering Profile

The light scattering profile was measured using a photogoniometer (GP-5 manufactured by Murakami. Color Research Laboratory Co., Ltd.). The light source was convergent light having an angle of 1.5°, and the acceptance angle of the detector was 2°. Light was incident from the normal direction of the resulting light scattering sheet, and the amount of transmitted and scattered light was measured while continuously changing the angle in the plane including the sheet normal line, thus obtaining the light scattering profile. For measuring the amount of the transmitted and scattered light, the amount of light of the light source in the state where there is no sheet was set to 1.

### (4) Evaluation of the Moire Elimination State

The evaluation of the “moire elimination” was performed by modifying a notebook personal computer.

### <Modification of a Notebook PC>

A notebook PC (R700-XP50K) manufactured by LG Display Co., Ltd. was disassembled; an upper diffusion sheet between backlight and a liquid crystal panel was removed; a polarizing plate on the side of the backlight stuck to the liquid crystal cell was removed; and thereto was stuck the light scattering sheet prepared as described above with an adhesive material. Note that the case where a polarizing plate without a light scattering sheet (Fujitac was used for both surfaces of a polarizing film as a protective film) was stuck was named as [Test 11].

Then, signals were input to the prepared liquid crystal display device through a video signal generator (VG-848; manufactured by Astrodesign, Inc.); gray display of 128/256 gradation was produced in solid display on the entire surface; the screen was visually observed from various directions in a dark room; and the presence or absence of the occurrence of moire was evaluated by the following moire evaluation criteria.

### <Evaluation Criteria of Moire Elimination>

A: Moire is not observed.
B: Moire is slightly observed.
C: Moire is clearly observed.

### [Test Results]

As shown in the table of FIG. 9, in the case of Examples 1 to 4 in which the coating layer was formed from the coating liquid A-1 in which a styrene-acrylonitrile copolymer (hereinafter referred to as “SAN”) was used as one of the two or more resin materials capable of phase-separation from each other, the “image definition” when the coating layer was subjected to high speed drying immediately after coating was 18%. When the high speed drying was performed 40 seconds after the low speed drying, the image definition was 25% which is the upper limit of the suitable range of “image definition”.

Further, the tilt angle distribution profiles when the low speed drying was performed for 0 to 40 seconds were in the range of 38 to 43%, which was sufficiently within the range of 21 to 50% which is the suitable range. Thereby, the moire elimination was evaluated as A.

On the other hand, in the case of Comparative Examples 1 to 3 whose coating layer was formed from the coating liquid A-2 in which cellulose acetate propionate was used as one of the two or more resin materials capable of phase-separation from each other, the “image definition” was 27% only when high speed drying was performed immediately after coating without performing low speed drying, which was a value close to 25% which is the upper limit of the suitable range. However, with the increase in the duration of low speed drying to 10 seconds and 40 seconds, the image definition increased to 39% and 65%, respectively.

Further, the tilt angle distribution profile when low speed drying was performed for 40 seconds in Comparative Example 3 was 16%, which was not within the range of 21 to 50% which is the suitable range. Thereby, the moire elimination was evaluated as C.

Further, in the case of Comparative Examples 4 to 6 in which the coating layers were formed from the coating liquids A-3 to A-5 in which polyester, polyester urethane or polymethylmethacrylate (hereinafter referred to as “PMMA”) was used as one of the two or more resin materials capable of phase-separation from each other, the “image definition” exceeded 70% even in the case where high speed drying was performed immediately after coating. Further, the moire elimination was evaluated as C for all of Comparative Examples 4 to 6.

As apparent from the results of Examples 1 to 4 and Comparative Examples 1 to 6, the light scattering sheet of the presently disclosed subject matter has achieved image definition (10% or more and less than 25%), a tilt angle distribution profile (21 to 50%), and the evaluation of moire elimination of A, which are suitable as a light scattering sheet, without being affected by the influence of low speed drying even when the low speed drying is performed in the initial drying immediately after coating.

On the other hand, in the case of a light scattering sheet prepared by using CAP, it was impossible to obtain a sheet which is fairly satisfactory as a light scattering sheet when high speed drying was not performed immediately after coating. Further, it was impossible to produce a satisfactory light scattering sheet by using polyester, polyester urethane or PMMA even when high speed drying was performed immediately after coating.

That is, the difference between Examples 1 to 4 of the presently disclosed subject matter and Comparative Examples 1 to 6 is that SAN was used in the presently disclosed subject matter as one of the resin materials. That is, it is considered that the occurrence of rotating convection in the coating layer can be suppressed even when low speed drying is performed immediately after coating because the nuclear growth of phase separation can be suppressed by using SAN. Thereby, the phase-separated convexo-concave structure of the light scattering sheet is formed into a sea-island structure of two or more resin materials, in which a plurality of domains constituting the islands have random shapes mainly having a string shape.

Therefore, in order to obtain a phase-separated convexo-concave structure of a low image definition in which transmitted image definition is low, high speed drying must be performed immediately after coating because, for example, in the case of CAP, if low speed drying is performed immediately after coating, CAP will be strongly affected thereby. If quick drying is performed immediately after coating, it is difficult to uniformly evaporate a solvent and the above-described optical properties will not be stabilized.

The fact that if high speed drying is performed immediately after coating, optical properties will not be stabilized will be described in the next Test B.

Therefore, when the light scattering sheet of the presently disclosed subject matter is used as a polarizing plate protective film on the side of the backlight of a liquid crystal display, a surface light source can be obtained in which luminance unevenness is not produced and front luminance is not reduced. It is also possible to produce a light scattering sheet having stable performance in which the variation in optical performance is small even when it is produced with a large area, and the influence of initial drying immediately after coating is minimized.

### [Test B]

In Test B, Examples 1, 2, and 4 of Test A were repeated in order to examine the stability of the optical properties in the case where high speed drying was performed immediately after coating.

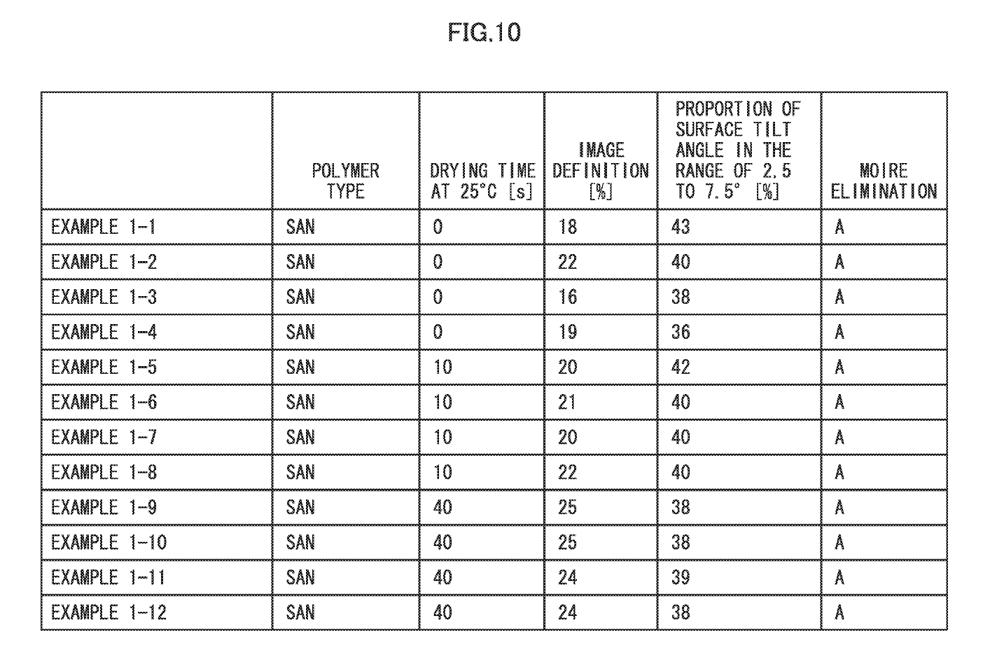

The results are shown in the table of FIG. 10. As shown in the table of FIG. 10, optical properties suitable as a light scattering sheet (image definition, a tilt angle distribution profile, and moire elimination) can be maintained for all the Examples 1-1 to 1-12, but the repeatability was poorer in the case where high speed drying was performed immediately after coating (drying time at 25° C. was zero second) than that in the case where the low speed drying time was 10 seconds and 40 seconds.

This has revealed that a light scattering sheet having stable optical properties can always be produced by performing low speed drying to equalize evaporation of a solvent.

### [Test C]

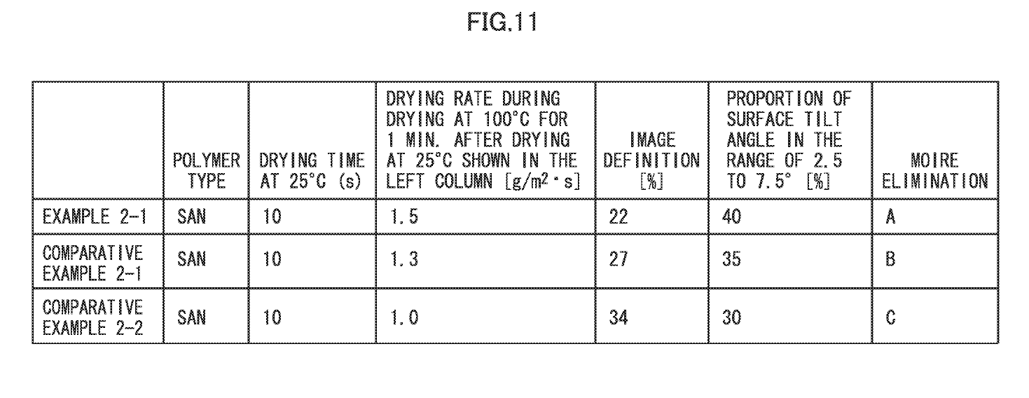

In Test C, as shown in FIG. 11, the coating layer was subjected to low speed drying at 25° C. for 10 seconds in the same manner as in Example 2 of Test A and then dried at three drying rates as described below to obtain light scattering sheet samples, which were compared in terms of “image definition”, “tilt angle distribution profile”, and “moire elimination”.

Example 2-1: The coating layer was dried at 1.5 g/m²·s.

Comparative Example 2-1: The coating layer was dried at 1.3 g/m²·s.

Comparative Example 2-2: The coating layer was dried at 1.0 g/m²·s.

In the above three kinds of drying, the coating layer was dried at 100° C. for 1 min., wherein the wind velocity (air volume) of drying was changed to change the drying rate to three drying rates of 1.0 g/m²·s, 1.3 g/m²·s, and 1.5 g/m²·s. Incidentally, the drying rate of drying at 100° C. for 1 min. was 2.05 g/m²·s in Test A because the wind velocity was higher than that in Example 2-1.

As a result, in the case of Comparative Examples 2-1 and 2-2 in which the drying was performed at a drying rate of 1.3 g/m²·s and 1.0 g/m²·s, respectively, the “tilt angle distribution profile” satisfied the range from 21 to 50% which is the suitable range, but the “image definition” exceeded the upper limit of the range from 10 to 25% which is the suitable range, and the moire elimination was evaluated as B to C.

On the other hand, in the case of Example 2-1 in which the drying was performed at a drying rate of 1.5 g/m²·s, good results were obtained for all of the “image definition”, “tilt angle distribution profile”, and “moire elimination”.

Considering the results of this Test C and also the fact that the drying rate in Test A was 2.05 g/m²·s, it is understood that it is important to subject the coating layer after the initial drying of the section until it reaches the critical solid concentration for phase separation to high speed drying at a drying rate of 1.5 g/m²·s or more.

### [Test D]

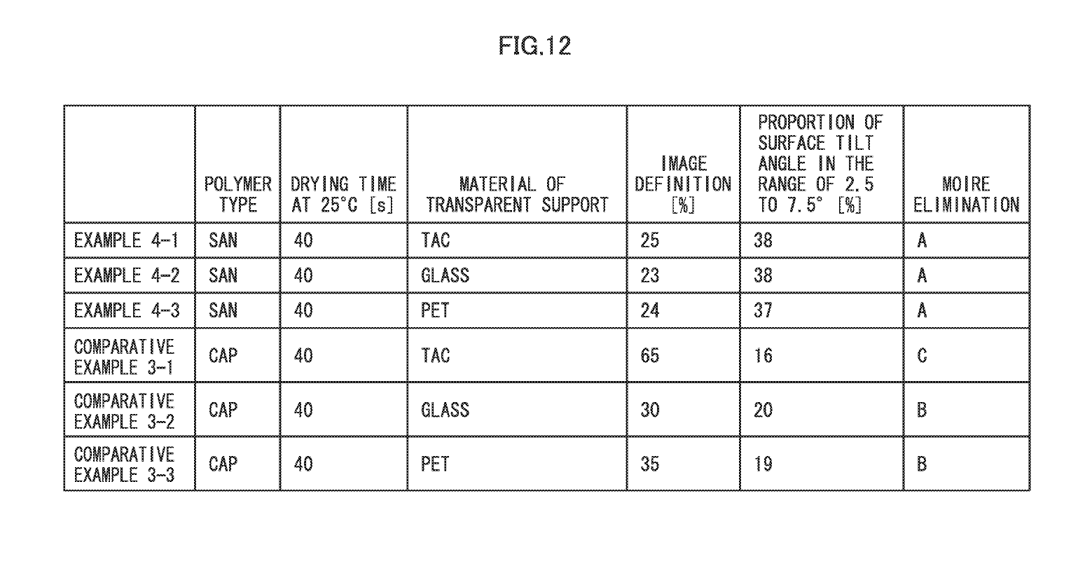

In Test D, the influence of the type of transparent supports on the optical performance was examined for Example 4 (SAN) and Comparative Example 3 (CAP) of Test A. The results are shown in the table of FIG. 12.

As apparent from the results in FIG. 12, in the case of Example 4 in which SAN was used as a resin material, image definition, a tilt angle distribution profile, and moire evaluation were almost unchanged even when the type of transparent supports was changed among TAC, a glass plate, and PET. When the light scattering sheet also serves as a protective sheet of a liquid crystal display, it is common that TAC is used as a transparent support because it has properties required for the protective sheet. Thus, the suitable performance as a light scattering sheet can be maintained by using TAC in the presently disclosed subject matter.

On the other hand, in the case of Comparative Example 3 in which CAP was used as a resin material, all of image definition, a tilt angle distribution profile, and moire evaluation were improved by using a glass plate and PET having lower solvent permeability than TAC. This is considered to be because phase separation is promoted at a stroke by the permeation of a solvent in the coating layer through a transparent support when TAC having high solvent permeability is used as the transparent support. Therefore, it is considered that the improvement in optical performance was observed in the glass plate and PET having low solvent permeability.

This has revealed that since the nuclear growth of phase separation can be suppressed by using SAN as one of the resin materials, the light scattering sheet is not only not affected by the influence of low speed drying in the initial drying, but hardly affected by the influence of the type of transparent supports.

### [Test E]

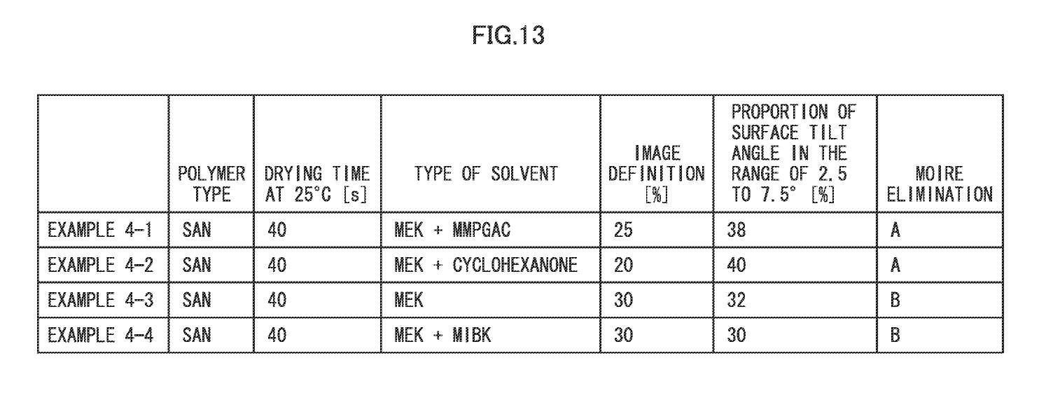

In Test E, the influence of the type of solvent on the optical performance was examined by using Example 4 (SAN) of Test A. The results are shown in the table of FIG. 13.

As shown in FIG. 13, a mixed solvent of MEK and MMPGAc (1:1) and a mixed solvent of MEK and cyclohexanone (1:1) have provided good results.

On the other hand, the image definition tends to be higher in the case where only a low boiling point solvent having a boiling point of less than 100° C. is used and in the case where a high boiling point solvent to be mixed has a boiling point of less than 120° C., such as MEK 100% and a mixed solvent of MEK and MIBK (1:1), respectively.

This is considered to be because a random sea-island structure mainly having a string shape can be further stably formed since the nuclear growth of phase separation can be suppressed by using a high boiling point solvent having a boiling point of 120° C. or higher such as MMPGAc and cyclohexanone in the mixed solvent.

What is claimed is:

1. A method for producing a light scattering sheet which is produced by forming, on a transparent support, a light scattering layer with a phase-separated convexo-concave structure formed by spinodal decomposition of a solution containing two or more resin materials capable of phase-separation from each other are dissolved in a solvent, the method comprising:
a coating step for coating the transparent support with a solution containing a styrene-acrylonitrile copolymer as one of the resin materials to form a coating layer;
a low speed drying step for drying the coating layer at room temperature in an initial drying of a section until the coating layer reaches a critical solid concentration for phase separation; and
a high speed drying step for drying the coating layer after the initial drying at a drying rate of 1.5 g/m²·s or more,
wherein the styrene-acrylonitrile copolymer is contained in the resin material composition of the coating layer to thereby suppress the nuclear growth of phase separation in the section of the initial drying so that the Marangoni number of the coating layer at the critical solid concentration for phase separation is less than 80.

2. The method for producing a light scattering sheet according to claim 1, wherein in the low speed drying step, the temperature of drying air is set to room temperature, while the air velocity of the drying air is increased with avoiding occurrence of drying unevenness.

3. The method for producing a light scattering sheet according to claim 1, wherein the resin materials comprise the styrene-acrylonitrile copolymer, an acrylic resin, and a polyfunctional monomer.

4. The method for producing a light scattering sheet according to claim 3, wherein the polyfunctional monomer is a photopolymerizable acrylate monomer.

5. The method for producing a light scattering sheet according to claim 1, wherein the transparent support is triacetyl cellulose permeable to the solvent.

6. The method for producing a light scattering sheet according to claim 1, wherein the solvent is preferably a mixed solvent of a low boiling point solvent having a boiling point of less than 100° C. and a high boiling point solvent having a boiling point of 120° C. or higher.

7. The method for producing a light scattering sheet according to claim 6, wherein the low boiling point solvent is methyl ethyl ketone, and the high boiling point solvent is cyclohexanone or methoxy propyl acetate.

8. A light scattering sheet comprising:
a transparent support; and
a light scattering layer on the transparent support, the light scattering layer having a phase-separated convexo-concave structure formed by spinodal decomposition of a solution containing two or more resin materials capable of phase-separation from each other are dissolved in a solvent,
wherein, in the light scattering layer, the phase-separated convexo-concave structure is formed into a sea-island structure of two or more resin materials including a styrene-acrylonitrile copolymer, and a plurality of domains constituting the islands have random shapes mainly having a string shape; and
a transmitted image definition measured according to JIS K 7374 using an optical comb having a width of 2.0 mm is 10% or more and less than 25%.

9. The light scattering sheet according to claim 8, wherein the resin materials comprise the styrene-acrylonitrile copolymer, an acrylic resin, and a polyfunctional monomer.

10. The light scattering sheet according to claim 9, wherein the polyfunctional monomer is a photopolymerizable acrylate monomer.

11. The light scattering sheet according to claim 9, wherein the angular distribution of transmitted light intensity is a Gaussian distribution, in the light scattering sheet.

12. The light scattering sheet according to claim 8, wherein the light scattering sheet has the phase-separated convexo-concave structure in which a proportion of region with a surface tilt angle in the range of 2.5° to 7.5° is 21% to 50%.

13. The light scattering sheet according to claim 8, wherein the transparent support is triacetyl cellulose permeable to the solvent.

14. The light scattering sheet according to claim 8, wherein the two or more resin materials have different refractive indices.
